(19) United States
(12) Patent Application Publication
(10) Pub. No.: US 2016/0034700 A1
(43) Pub. Date: Feb. 4, 2016

(54) SEARCH PERMISSIONS WITHIN HIERARCHICALLY ASSOCIATED DATA

(71) Applicant: INFOTRAX SYSTEMS, L.C., Orem, UT (US)

(72) Inventors: Larry Nash, Provo, UT (US); Dan Floyd, West Jordan, UT (US); Mark Rawlins, Lehi, UT (US); Jake Stowell, Orem, UT (US)

(21) Appl. No.: 14/811,555

(22) Filed: Jul. 28, 2015

Related U.S. Application Data
(60) Provisional application No. 62/031,749, filed on Jul. 31, 2014.
(60) Provisional application No. 62/133,652, filed on Mar. 16, 2015.

(51) Int. Cl. G06F 21/62; G06F 17/30

(52) U.S. Cl. CPC G06F 21/6218; G06F 17/30554

(57) ABSTRACT

A server computer system can receive a database query directed towards returning information from one or more locations within a hierarchically organized data structure. A user identification can be associated with a particular entry within the hierarchically organized data structure. The system can then access an ordered flat file database that comprises the information stored within the hierarchically organized data structure. The stored information can include information associating each entry within the hierarchically organized data structure with the entry's relative position within the hierarchically organized data structure. The system can also return a query response that excludes particular information based upon a permission attribute applied to sequential entries within the ordered flat file database.

### CROSS-REFERENCE TO RELATED APPLICATIONS

This application claims priority to and the benefit of U.S. Provisional Application Ser. No. 62/031,749, entitled “Search Permissions with Hierarchically Associated Data,” filed on Jul. 31, 2014 and U.S. Provisional Application Ser. No. 62/133,652, entitled “Search Permissions with Hierarchically Associated Data,” filed on Mar. 16, 2015. The entire contents of each of the above applications is incorporated herein by reference in their entireties.

### BACKGROUND OF THE INVENTION

1. Technical Field

The present invention relates generally to computer-based database systems

2. Background and Relevant Art

Many businesses store hierarchically organized data in databases where any entry (or row) may be the parent of one or more child entries (or rows) within the database. A typical hierarchically organized database stores data in a relational database table. Although standard relational database access techniques can be used to access and process hierarchical data stored in this manner, these techniques can be slow especially when the hierarchical structure is large.

These slower techniques that have been used for accessing and processing hierarchical data have limited the number and type of real-time applications that consume the hierarchical data. In one example, multi-level marketing (“MLM”) companies maintain hierarchical data structures representing the hierarchy of individuals participating in the multi-level marketing system.

A typical hierarchical database will store many different pieces of data for each individual such as the total amount of sales for the individual in a specified period, a number of new customers obtained in a specified period, and other similar pieces of data. One common computation performed on the hierarchical data is the calculation of commissions based on the total amount of sales for each individual. One individual's commission is generally based not only on the individual's sales, but the sales of other individuals under the individual in the hierarchy. In a large hierarchy, it may take a relatively long time to calculate the commission, or to calculate another figure that is dependent on the hierarchical relationships, for an individual.

Many businesses and organizations desire to give employees and contractors access to certain portions of the data stored within the hierarchy. For example, a MLM company may wish to give a particular salesperson access to their own sales information, along with the sales information of individuals that the particular salesperson enrolled, which would appear below the particular salesperson in the hierarchy. In some of these cases, however, the MLM company may wish to limit the particular salesperson's access to only the sales data of others, and not allow the particular salesperson to access personal information that is stored within the hierarchy. Additionally, in at least one implementation, the MLM company may wish to limit the particular salesperson's access to only individuals that meet a predefined criteria.

Accordingly, there are a number of problems with hierarchically stored information that can be addressed.

### BRIEF SUMMARY OF THE INVENTION

The present invention solves one or more problems in the art with methods, systems, and computer program products for applying and enforcing permissions associated with hierarchically organized data. In particular, implementations of the present allow an administrator to create permissions that either allow or disallow a variety of different groups to access specific information within the hierarchically organized data. For example, different permissions can be applied to different users and the permissions can restrict or allow access to specific entries, specific data fields within the entries, and/or specific branches of the hierarchically organized data.

For example, in at least one implementation, a server computer system receives a database query directed towards returning information from one or more locations within a hierarchically organized data structure. The system can then identify a user identification that is associated with the initiation of the database query. The user identification can be associated with a particular entry within the hierarchically organized data structure. The system can then access an ordered flat file database that comprises the information stored within the hierarchically organized data structure. The stored information can include information associating each entry within the hierarchically organized data structure with the entry's relative position within the hierarchically organized data structure. The system can also return a query response that excludes particular information based upon a permission attribute. The permission attribute can be applied to sequential entries within the ordered flat file database.

In an additional implementation, a client computer console can retrieve data from one or more hierarchically organized data trees maintained in a database. The client computer console can identify a query of interest. The query of interest can be directed towards returning information gathered from multiple entries within a specific branch of a hierarchically organized data structure. Additionally, the client computer console can submit the query of interest to a database system. The database system can comprise the hierarchically organized data structure stored within an ordered flat file database. The computer system can then receiving a query response to the query of interest. The query response can exclude information from at least a portion of the ordered flat file database based upon a permission attribute.

Additional features and advantages of exemplary implementations of the invention will be set forth in the description which follows, and in part will be obvious from the description, or may be learned by the practice of such exemplary implementations. The features and advantages of such implementations may be realized and obtained by means of the instruments and combinations particularly pointed out in the appended claims. These and other features will become more fully apparent from the following description and appended claims, or may be learned by the practice of such exemplary implementations as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof, which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an exemplary computer environment in which the present invention may be implemented;

FIG. 2 illustrates exemplary hierarchically organized data and an exemplary ordered flat file derived from the data;

FIG. 3 illustrates an additional exemplary hierarchically organized data and an additional exemplary ordered flat file derived from the data;

FIG. 4 is a flowchart of an exemplary method implemented by one or more embodiments of the invention; and

FIG. 5 is a flowchart of another exemplary method implemented by one or more embodiments of the invention.

### DETAILED DESCRIPTION OF THE PREFERRED EMBODIMENTS

The present invention extends to methods, systems, and computer program products for applying and enforcing permissions associated with hierarchically organized data. In particular, implementations of the present allow an administrator to create permissions that either allow or disallow a variety of different groups to access specific information within the hierarchically organized data. For example, different permissions can be applied to different users and the permissions can restrict or allow access to specific entries, specific data fields within the entries, and/or specific branches of the hierarchically organized data.

Accordingly, one or more implementations of the present invention allow administrators to control the access that various users have to data stored within a hierarchal tree. For example, an administrator can restrict users from accessing any data that is not directly within the user's downline. Additionally, an administrator can create permissions that are only applied in predefined situations. For instance, an administrator can create a rule that prevents users from specific geographic locations from accessing specific data fields within the hierarchal data structure. Additionally, in at least one implementation, multiple filters can be applied to any given user or user request. As used within the application, “users” and “salespersons” can be used interchangeably. While implementations of the present invention may provide particular benefit to salespersons, users who are not salespersons may also benefit from the invention discussed herein.

Additionally, at least one implementation of the present invention provides particular benefits within a hierarchically organized data structure that has been stored within an ordered flat file. In particular, permissions within a hierarchically organized data structure may be, at least in part, based upon a particular element's relative position within the structure. Conventional methods of searching hierarchically organized data structures often involve resource and time intensive recursion. For example, searching a hierarchically organized data structure may require traversing at least portions of the hierarchy multiple times as each individual branch and sub-branch is followed to it terminal entry.

Additionally, applying permissions within a hierarchically organized data structure can dramatically increase computational costs even further. For instances, applying multiple different permissions that are based upon each entries relative locations within a hierarchically organized data structure may require recursively traversing each entry multiple times for each individual permission. As such, determining the relative position of elements within a hierarchically organized data structure with respect to each other can be a computationally intensive exercise. In contrast, each of these processes can be performed quickly and highly efficiently within an ordered flat file. Accordingly, in at least one implementation, applying the novel permission schemes disclosed herein to a hierarchically organized data structure that has been stored within an ordered flat file can provide significant benefits.

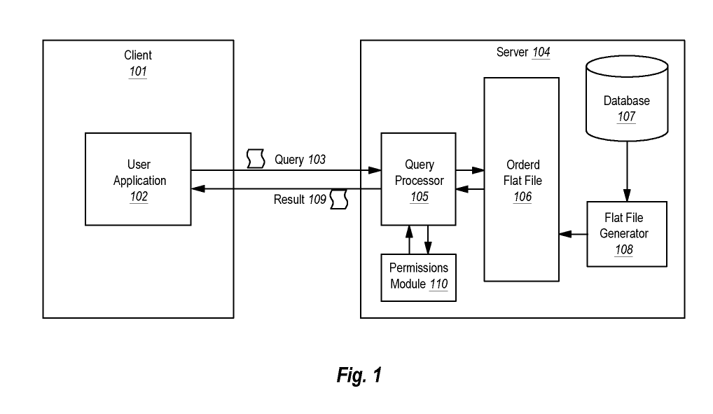

For example, FIG. 1 illustrates a generalized computer environment including a client 101 and a server 104 according to embodiments of the present invention. Client 101 may be any computer including a desktop, laptop, smart phone, or any other computing device. User application 102 on client 101 is an application that sends queries to server 104 for viewing hierarchical data stored in database 107. For example, user application 102 may be a general purpose web browser, or may be a dedicated local or web-based application. One will understand, however, the the system of FIG. 1 is merely exemplary and that in various implementations the invention can be performed within a single device, within a plurality of devices, within a plurality of remotely distributed devices, or within any other computing environment.

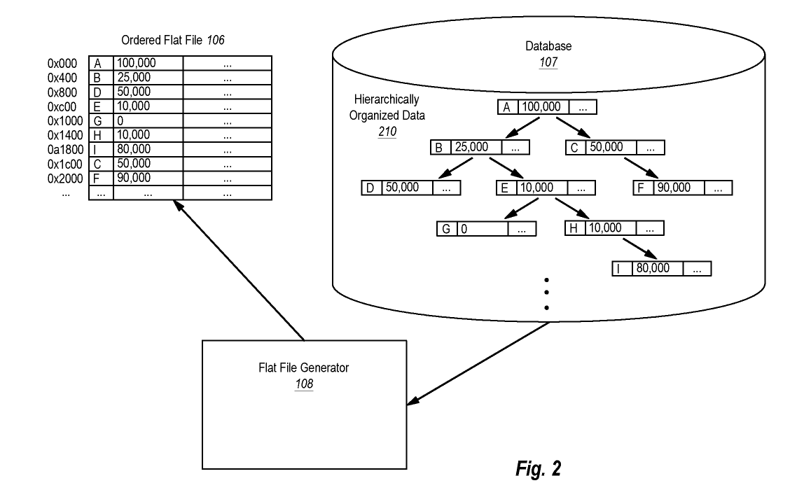

To expedite the processing of such queries, at least one implementation of the present invention involves use of a flat file generator 108 on server 104 to create and maintain an ordered flat file 106. The ordered flat file 106 stores at least some of the hierarchical data of the database 107 as a flat file that maintains the hierarchical organization of the data as will be further described below with reference to FIG. 2. When a query is received from user application 102, the query processor 105 on server 104 accesses the permissions module 110 to determine what permissions should be applied to the query. The query processor 105 then accesses the permitted data fields and entries within the ordered flat file 106 to resolve the query rather than accessing the underlying data in database 107. In some implementations, after initially creating the flat file 106, the hierarchal data in the database 107 can be deleted.

FIG. 2 depicts a database 107, which stores exemplary hierarchically organized data 210. The hierarchically organized data 210 comprises a plurality of elements that each has at least one parent child relationship with another element. Within this disclosure, “elements” and “entries” are used interchangeably, whereas, “fields” are subcomponents of elements. FIG. 2 also illustrates an exemplary ordered flat file 106 created from the hierarchically organized data 210 by flat file generator 108. Hierarchically organized data 210 is shown as a tree structure for ease of illustration; however, an ordered flat file can be created from an underlying database of any type or format (e.g., relational, flat file, etc.).

The ordered flat file 106 is structured such that all direct descendants of an element are listed directly below the element within the flat file. For example, because element A is the base node and all other elements are descendants of element A, it is listed first in the ordered flat file. Next, element B is listed with all its direct descendants listed directly below it and prior to any other element that is at the same level or a higher level in the hierarchy than element B. For example, element C (which is at the same level as element B (i.e., a brother of element B) is listed after all of element B's direct descendants (elements D, E, G, H, and I). As indicated by the ordered flat file 106, this process of ordering continues throughout the entire ordered flat file 106.

As depicted in FIG. 2, the various elements (A, B, D, E, . . . ) are depicted as being directly adjacent to each other in memory. In at least one implementation, however, the elements are not necessarily next to each other in memory. Instead, the various elements can be linked in the same order depicted in the ordered flat file 106 using pointers. For example, Element B can include a pointer to the memory location of element D and element A. Accordingly, Element B could identify that Element A is directly above it in the ordered flat file 106 and that Element D is directly below it.

In this way, any element's descendants can be quickly determined by reading the ordered flat file 106 until an element with the same or higher level in the hierarchy is reached. For example, it can quickly be determined that element I does not have any descendants because the next element below element I in the ordered flat file 106 is element C, which is a brother to element B, and is three levels higher than element I in the hierarchy.

In at least one implementation, each element within the ordered flat file can comprise a field that indicates the element's hierarchical parent. For example, element C can comprise a field that indicates that element A is element C's parent. As such, when traversing the ordered flat file from element I to element C, it can be determined that element C is not a child of element I, because C comprises an indication its parent is element A. Further, in at least one implementation, each element can comprise a field that indicates the elements relative position with the hierarchy. For example, element A may comprise a field that indicates that it is in level 1, while elements D, E, and F may comprise fields that indicate they are within level 3. As such, when traversing the ordered flat file from element I to element C, it can be determined that element C is not a child of element I, because element C comprises an indication that it is within level 2 of the hierarchy and element I comprises an indication that it is in level 5 of the hierarchy. Accordingly, various implementations can be used to determine an element's relative position within the hierarchically organized data 210.

The listed fields in the ordered flat file 106 of FIG. 2 represent the element's name (or identifier) and a total sales amount for the person represented by the element. However, an ordered flat file can include any number of fields storing any type of data as indicated by the ellipses. For example, FIG. 2 illustrates an implementation in which each element in the ordered flat file 106 can include a field that defines the element's level in the hierarchy, or that may indicate a person's (represented by the element) title, rank, or position in a company structure, as well as other fields containing data that may be used to calculate reports. The ordered flat file 106 of FIG. 2 depicts elements that are 1 KB in size as represented by the hexadecimal addresses to the left of each element. However, any size may be allocated to elements in the hierarchy, and each element may in fact be a different size. One will appreciate that, in at least one embodiment, each element is the same size.

An ordered flat file can be particularly beneficial in representing a “downline” of an individual in a hierarchical organization, such as a multi-level marketing business structure. An individual's downline in a multi-level marketing hierarchy refers to the individual and all other individuals that fall below the individual in the hierarchy. Using the example of FIG. 2, element B's downline would include elements D, E, G, H, and I (but not C, F).

As can be seen, this downline can quickly be determined by sequentially reading the ordered flat file from element B to element I and stopping before elements C and F. In particular, a database system can know to stop before element C because element C is at the same or a higher relative position within the hierarchically ordered data 210 as element B. Element C's relative position within the hierarchically organized data 210 can be determined using any of the methods disclosed above.

Generally, it is faster to access hierarchical data stored in an ordered flat file than it is to access the same data stored in an underlying database. Therefore, calculations based on hierarchical data, such as commissions as previously described, can be performed more quickly by creating an ordered flat file of the hierarchical data, and accessing the hierarchical data within the ordered flat file to generate the required result set.

An ordered flat file may be created from a hierarchical dataset stored in an underlying database at various times. For example, a multi-level marketing business may update its database with sales figures at the end of each business day. After the updates are entered each day, a complete ordered flat file may be generated to represent the state of the hierarchical data after the updates for that day are entered. Of course, an ordered flat file may be created at any interval. Additionally, in at least one embodiment, an existing flat file can be updated to reflect new information by individually accessing and updating each required data field. For example, a new element could be added to an ordered flat file 106 by updating one or more pointers to include the new element at the correct location within the file.

Generally, a query for data of a hierarchical dataset requests a sub-portion of the hierarchical dataset. One example includes a query for an individual's downline. As described above, the sub-portion of hierarchical data can be obtained by reading a sequential portion of the ordered flat. To locate the beginning of the sequential portion to be read, a starting element must be identified. For example, to locate the beginning of element B's downline, element B must be identified in the ordered flat file.

At least two approaches can be taken to locate the beginning of the sequential portion: sequential access and random access. Sequential access refers to reading from the beginning of the ordered flat file and continuing to read the elements in the ordered flat file until the first element of the sequential portion is identified. Once the first element is identified, any permissions (i.e., filtering conditions) in the query can be applied to the elements in the portion as the elements are read.

Random access, on the other hand, refers to reading an element of the ordered flat file without first reading the preceding elements in the ordered flat file. Random access can be accomplished by maintaining a location index for each element in the ordered flat file. Reading the element's location within the index and then accessing the ordered flat file at the address provided by the index can determine an element's location in the ordered flat file. In at least one implementation, the index and/or the flat file can be addressed using a hash map.

In either sequential or random access, once the first element of the sequential portion is identified, the remaining elements of the sequential portion can quickly be retrieved by sequentially reading the ordered flat file until an element that is at the same or higher level in the hierarchy is identified at which point no further reads need to be performed. As each element in the sequential portion is read, the filtering criteria can be applied to generate one or more result sets. In other words, only a single pass of the ordered flat file may be required to identify the relevant portion and to apply the permissions to the portion to generate one or more result sets.

As described above, implementations of the present invention provide methods and systems for quickly accessing data elements from within hierarchal tree structures. In addition to the ability to quickly access the data element, in at least one implementation, various permissions or filters can be applied to the query results. In particular, one or more administrators can create rules that determine what information a given user can access and retrieve from within the database.

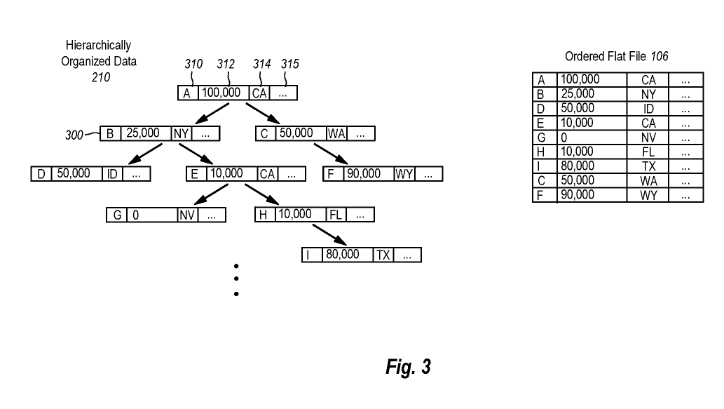

For example, FIG. 3 depicts the hierarchically organized data 210 and the ordered flat file 106 from FIG. 2. Both the hierarchically organized data 210 and salesperson, a sales amount field 312, which indicates the amount of money the the ordered flat file 106 include an identification field 310, which identifies a particular associated salesperson generated for a time period, a state field 314, which indicates the home state of the salesperson, and various additional fields 315. As depicted, each of the aforementioned fields are indicated with respect to entry A; however, one will understand that this is just for clarity purposes and that each of the referenced fields are also present within the other entries.

In at least one implementation, various users may access information within the ordered flat file 106. In particular, one or more salespersons, who are included as an entry within the ordered flat file 106, can access information relating to their own records, and, in some cases, information from the records of other salespersons. For example, in a typical MLM company, a salesperson can enroll additional salespersons below them in the company hierarchy. The salesperson can then receive a commission based upon the sales that were made by the enrollees below the salesperson in the hierarchy.

Accordingly, one will understand why a salesperson may desire to access information relating to the performance of his or her enrollees. One will also understand, however, that an MLM company may desire or be obligated to protect certain personal information that may be stored within the ordered flat file 106 from being accessed by anyone other than designated company officers. Additionally, in various implementations an MLM company may desire to provide a salesperson with some general information from all of his or her downline, but only provide detailed, specific information for a smaller portion of that downline.

Additionally, various MLM companies may desire to provide all salespersons access to certain cumulative information gathered from the entire ordered flat file 106, including information outside of the salepersons' downlines. For example, an MLM company may provide all salespersons access to information relating to the current total company sales, the sales amount of the highest achieving salesperson, the salesperson with the highest number of enrollees, etc. Alternatively, an MLM company may provide cumulative information for a salesperson's entire downline, and specific information for certain sections of their downline.

In order to generate this and similar information, a salesperson may need access to information stored throughout the entire ordered flat file 106. As stated above, one will understand that an MLM company may desire to allow a salesperson to gather instantly updated information relating to the above mentioned categories from the ordered flat file 106, while at the same time protecting specific information from being accessed.

Accordingly, in at least one implementation, an administrator can create permissions and rules, or conditions, defining when the permissions should be applied. In at least one implementation, the rules can comprise Boolean expressions. An administrator can be any individual, group, or entity to whom the server 104 and/or the user application 102 has granted the rights to create permissions. In some cases, some administrators are only able to create permissions that apply to specific entries, data fields, and/or rules.

Returning to FIG. 3, a salesperson B may desire to access information relating to the total sales of his downline enrollees. Accordingly, salesperson B can submit a query 103 to the query processor 105 that requests the desired information. Upon receiving the query 103, the query processor can identify that the requestor 300 is associated with salesperson B and then access the permission module 110 and determine whether salesperson B has the necessary permissions to access the requested information. In this exemplary embodiment, permissions may allow the salesperson to receive a cumulative sales amount from their downline enrollees. Upon verifying with the permissions module 110 that salesperson B has permission to receive the requested information, the query processor 105 can access the ordered flat file 106 and calculate the total sales of salesperson B's downline enrollees in this case, the cumulative sales of salesperson D, salesperson E, salesperson G, salesperson H, and salesperson I.

As an additional example, salesperson B may submit a query 103 requesting the telephone numbers of each of the enrollees in salesperson B's downline. In at least one implementation, however, some states or countries may have privacy laws in place that prevent the sharing of personal contact information. Accordingly, the query 103 is received by the query processor 105 and the query processor 105 accesses the permissions module 110 to determine whether salesperson B has the necessary permission to receive the requested data. For example, the permissions module 110 can include a rule that prevents the sharing of personal contact information for any person who is a resident of the state of California (or any other jurisdiction, such as an entire country).

Upon receiving the permissions and rules from the permissions module 110, the query processor 105 can then access the ordered flat file, and while processing the query, determine which, if any, of the enrollees below salesperson B are residents of California. This determination can be made by accessing information that is associated with each entry within the ordered flat file 106. Once the information is processed, the query processor 105 can provide salesperson B with the phone numbers of each enrollee in the downline, except for enrollee E, who is from California.

While the previously stated example involves a permission rule based upon the state of residence of each enrollee, one will understand that an administrator can create various rules that are based on a wide variety of different information and circumstances. For instance, the permissions module 110 can contain a rule that only allows salespersons to access information relating to downline enrollees that are within two levels downline from the user. In other words, this rule would allow the query processor 105 to traverse and return results relating to salesperson D, salesperson E, salesperson G, and salesperson H. Salesperson B, however, would not be allowed to access information relating to salesperson I, because salesperson I is more than two levels below salesperson B.

In at least one implementation, when processing the above query, the query processor 105 can continue to traverse the ordered flat file 106 until it reaches the terminal entry I. The query processor 105 may recognize I as the terminal entry because the following entry C comprises the same level in the hierarchy as entry B, which is associated with Salesperson B. In this particular example, because the query was directed to salespersons B's downline, the query processor can determine it has finished its search when it reaches an entry (in this case entry C) that is at the same level, or higher, in the hierarchy as element B. As such, the search can be performed in a highly efficient sequential manner that involves traversing directly down the ordered flat file 106.

As a further example, the permissions module 110 can include rules that only selectively apply based upon information relating to the originator of a query 103. For example, a rule can apply specific permissions to all requests that are generated by salespersons from New York. As such, a rule can be created that would apply to from queries initiated by salesperson B because salesperson B is New York. As an example rule, a rule can be created that prevents anyone from New York from accessing the contact information of any downstream enrollee who is under the age of twenty-one. As depicted in FIG. 3, if Salesperson D was only 19, this rule would prevent salesperson B from accessing the contact information of Salesperson D.

As described above, in at least one implementation, multiple permissions can be applied to a single query. For example, salesperson B can initiate a query 103 directed towards returning the phone number of every salesperson within the entire MLM's hieratically organized data 210. When the query processor 105 receives this query 103 and accesses the permissions module 110, the query processor 105 can identify the various permissions that should be applied to the query 103.

Relying upon the rules and permissions recited above, the query processor 105 can identify the rule that only allows salespersons to access information relating to downstream enrollees that are within two levels of the downstream from the user. Additionally, the query processor 105 can identify the rule that prohibits the sharing of personal contact information for any person who is a resident of the state of California. Further, the query processor 105 can identify the rule that prevents anyone from New York from accessing the contact information of any downstream enrollee who is under the age of twenty-one.

In response to the query 103, the query processor 103 can provide salesperson B with the phone number of salesperson G and salesperson H. The query processor 103 will not return the phone numbers of salesperson A, C, F, or I because each of these salespersons are outside the group of salespersons that are within two downline levels of salesperson B. Additionally, the query processor 103 will not return the phone number of salesperson E because salesperson E is from the state of California. Further, the query processor will not return the phone number of salesperson D because the query was initiated by salesperson B, who is from New York, and salesperson D is under the age of 21.

In at least one implementation, if the permissions and/or rules ever conflict the query processor 105 defaults to not providing access to the information. In this way, the query processor 105 is configured to provide too little information, as opposed to too much information, when a conflict occurs. Additionally, in response to the conflict an administrator can be notified that the conflict occurred, who initiated the request, and what information was blocked from being provided to the requestor.

Accordingly, implementations of the present invention can quickly access hierarchically organized data, apply multiple complex permissions and return a requested data set. In particular, implementations of the present invention can sequentially traverse an ordered flat file 106 and apply multiple permissions simultaneously to an entry. Additionally, implementations of the present invention can quickly determine an entry's downline without recursively traversing multiple potential branches and sub-branches. Further, implementations of the present invention can sequentially traverse multiple entries within an ordered flat file and quickly identify each entry's relative position within a hierarchy.

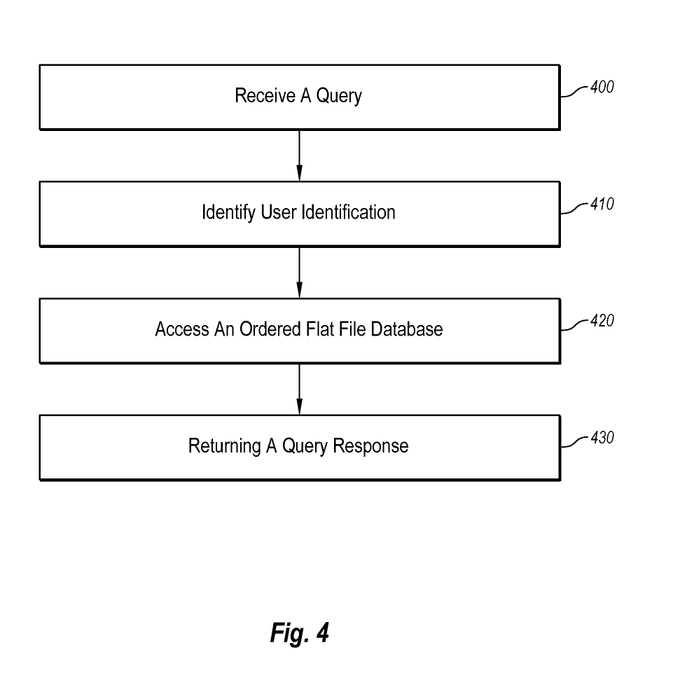

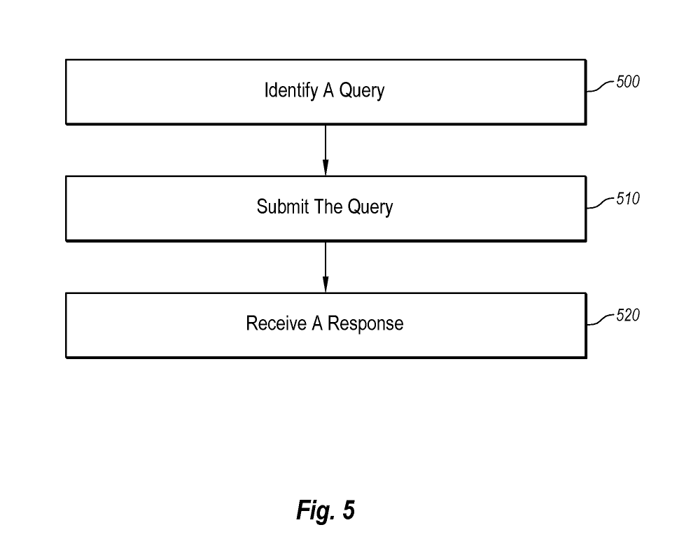

Accordingly, FIGS. 1-3 and the corresponding text illustrate or otherwise describe one or more methods, systems, and/or instructions stored on a storage medium for managing permissions within a hierarchically organized database. One will appreciate that implementations of the present invention can also be described in terms of methods comprising one or more acts for accomplishing a particular result. For example, FIGS. 4 and 5 and the corresponding text illustrate flowcharts of a sequence of acts in a method for managing permissions within a hierarchically organized database. The acts of FIGS. 4 and 5 are described below with reference to the components and modules illustrated in FIGS. 1-3.

For example, FIG. 4 illustrates that an implementation of a method for managing permissions within a hierarchically organized database can comprise an act 400 of receiving a query. Act 400 includes receiving a database query directed towards returning information from one or more locations within a hierarchically organized data structure. For example, in FIG. 1 and the accompanying description, query 103 is directed towards returning information that is stored within the ordered flat file 106.

FIG. 4 also shows that the method can comprise an act 410 of identifying a user identification. Act 410 includes identifying a user identification that is associated with the initiation of the database query. The user identification can also be associated with a particular entry within the hierarchically organized data structure. For example, in FIG. 3 and the accompanying description, salesperson B initiates a query. Upon receiving the query 103, query processor 105 determines that the requestor 300 is associated with salesperson B. For instance, a user may be required to log into the system prior to use.

Additionally, FIG. 4 shows that the method can include an act 420 of accessing an ordered flat file database. The ordered flat file database 106 can comprise the information stored within the hierarchically organized data structure 210. In particular, the information can include information associating each entry within the hierarchically organized data structure with the entry's relative position within the hierarchically organized data structure. For example, FIG. 2 and the accompanying description describe hierarchically organized data 210 that has been stored within an ordered flat file 106. As described and depicted, the ordered flat file 106 maintains information that associates each entry within the ordered flat file 106 with the entry's relative location within the hierarchically organized data structure 210. The query processor 105 can access the ordered flat file 106 (i.e., the order flat file database) to query the data.

FIG. 4 also shows that the method can include an act 430 of returning a query response. Act 430 includes returning a query response that excludes particular information based upon a permission attribute. The permission attribute can be applied to sequential entries within the ordered flat file database. For example, in FIG. 3 and the accompanying description, salesperson B initiates a query 103 directed towards returning information from the ordered flat file 106. In response to the query 103, the query processor 105 excluded some of the requested information because of specific rules and permissions that apply to salesperson B and the information within the database. For example, salesperson B is only allowed to access information that is within two downline levels of salesperson B within the hierarchically organized data 210. Accordingly, the permission attribute is applied to sequential entries below the entry for salesperson B within the ordered flat file 106

In at least one implementation a user application can be used to perform at least a portion of the described method. For example, FIG. 5 illustrates that an implementation of a method for managing permissions within the database can comprise an act 500 of identifying a query. Act 500 includes identifying a query of interest. The query of interest can be directed towards returning information gathered from multiple entries within a specific branch of a hierarchically organized data structure. For example, in FIG. 1 and the accompanying description, a user application 102 identifies a query of interest 103 that is directed towards returning information from a hierarchically organized data structure.

FIG. 5 also shows that the method can comprise an act 510 of submitting the query. Act 510 includes submitting the query of interest to a database system. The database system can comprise a hierarchically organized data structure stored within a flat file. For example, in FIG. 1, and the accompanying description, the user application 102 submits the query 103 to the query processor 105, which, in turn, accesses an ordered flat file 106.

Additionally, FIG. 5 also shows that the method can comprise an act 520 of receiving a response. Act 520 includes receiving a query response to the query of interest 103. The query response can exclude information from at least a portion of the ordered flat file database based upon a permission attribute. For example, in FIG. 1, and the accompanying description, the user application 102 submits the query 103 to the query processor 105, which, in turn, accesses an ordered flat file 106. As described above, a permission attribute may prevent the query response from containing information from various entries. For instance, a permission attribute may prevent the query response from containing information relating to a particular user's personal information.

Accordingly, implementations of the present invention provide significant computational and processing efficiencies when requesting data and processing permissions. In particular, implementations of the present invention can access data and apply permissions to sequential data entries during a single pass of the ordered flat file 106. Further, implementations of the present invention can quickly apply position-relative permissions without traversing multiple branches and sub-branches to determine relative positions of various related entries.

Although the subject matter has been described in language specific to structural features and/or methodological acts, it is to be understood that the subject matter defined in the appended claims is not necessarily limited to the described features or acts described above, or the order of the acts described above. Rather, the described features and acts are disclosed as example forms of implementing the claims.

Embodiments of the present invention may comprise or utilize a special-purpose or general-purpose computer system that includes computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general-purpose or special-purpose computer system. Computer-readable media that store computer-executable instructions and/or data structures are computer storage media. Computer-readable media that carry computer-executable instructions and/or data structures are transmission media. Thus, by way of example, and not limitation, embodiments of the invention can comprise at least two distinctly different kinds of computer-readable media: computer storage media and transmission

Computer storage media are physical storage media that store computer-executable instructions and/or data structures. Physical storage media include computer hardware, such as RAM, ROM, EEPROM, solid state drives (“SSDs”), flash memory, phase-change memory (“PCM”), optical disk storage, magnetic disk storage or other magnetic storage devices, or any other hardware storage device(s) which can be used to store program code in the form of computer-executable instructions or data structures, which can be accessed and executed by a general-purpose or special-purpose computer system to implement the disclosed functionality of the invention.

Transmission media can include a network and/or data links which can be used to carry program code in the form of computer-executable instructions or data structures, and which can be accessed by a general-purpose or special-purpose computer system. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer system, the computer system may view the connection as transmission media. Combinations of the above should also be included within the scope of computer-readable media.

Further, upon reaching various computer system components, program code in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at one or more processors, cause a general-purpose computer system, special-purpose computer system, or special-purpose processing device to perform a certain function or group of functions. Computer-executable instructions may be, for example, binaries, intermediate format instructions such as assembly language, or even source code.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The invention may also be practiced in distributed system environments where local and remote computer systems, which are linked (either by hardwired data links, wireless data links, or by a combination of hardwired and wireless data links) through a network, both perform tasks. As such, in a distributed system environment, a computer system may include a plurality of constituent computer systems. In a distributed system environment, program modules may be located in both local and remote memory storage devices.

Those skilled in the art will also appreciate that the invention may be practiced in a cloud computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

A cloud computing model can be composed of various characteristics, such as on-demand self-service, broad network access, resource pooling, rapid elasticity, measured service, and so forth. A cloud computing model may also come in the form of various service models such as, for example, Software as a Service (“SaaS”), Platform as a Service (“PaaS”), and Infrastructure as a Service (“IaaS”). The cloud computing model may also be deployed using different deployment models such as private cloud, community cloud, public cloud, hybrid cloud, and so forth.

Some embodiments, such as a cloud computing environment, may comprise a system that includes one or more hosts that are each capable of running one or more virtual machines. During operation, virtual machines emulate an operational computing system, supporting an operating system and perhaps one or more other applications as well. In some embodiments, each host includes a hypervisor that emulates virtual resources for the virtual machines using physical resources that are abstracted from view of the virtual machines. The hypervisor also provides proper isolation between the virtual machines. Thus, from the perspective of any given virtual machine, the hypervisor provides the illusion that the virtual machine is interfacing with a physical resource, even though the virtual machine only interfaces with the appearance (e.g., a virtual resource) of a physical resource. Examples of physical resources including processing capacity, memory, disk space, network bandwidth, media drives, and so forth.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

We claim:

1. At a server computer system that receives queries from one or more client computers for accessing hierarchically organized elements maintained in a database, a computerized method for managing permissions within the database, the method comprising:
receiving a database query directed towards returning information from one or more locations within a hierarchically organized data structure;
identifying a user identification that is associated with the initiation of the database query;
accessing an ordered flat file database, wherein the ordered flat file database comprises the information stored within the hierarchically organized data structure, including information associating each entry within the hierarchically organized data structure with the entry's relative position within the hierarchically organized data structure, wherein accessing the ordered flat file database includes ignoring specific entries within the hierarchically organized data structure that do not correspond to a permission attribute; and
returning a query response that excludes the ignored information based on the permission attribute, wherein the permission attribute is applied to sequential entries within the ordered flat file database.

2. The method as recited in claim 1, wherein the permission attribute is associated with a particular entry's relative position within the hierarchically organized data structure.

3. The method as recited in claim 2, wherein the permission attribute is applied to sequential entries within the ordered flat file database until a terminal entry is reached that indicates there are no further entries within the ordered flat file database that are allowable by the permission attribute.

4. The method as recited in claim 3, wherein:
the permission attribute limits the query to only entries that are within a specific number of levels downstream from the particular entry; and
the terminal entry comprises the first entry sequentially downstream from the particular entry that comprises a relative position within the hierarchically organized data structure that is greater than the particular entry's relative position within the hierarchically organized data structure.

5. The method as recited in claim 1, wherein the permission attribute is associated with at least one specific attribute stored within one or more fields of a particular entry associated with the user identification.

6. The method as recited in claim 5, wherein the permission attribute is associated with at least one specific attribute stored within one or more fields of an entry other than the particular entry.

7. The method as recited in claim 6, wherein the at least one specific attribute comprises the relative position of the particular entry within the hierarchically organized data structure.

8. The method as recited in claim 6, wherein the at least one specific attribute comprises a geographic location associated with the user identification.

9. The method as recited in claim 1, wherein the permission attribute can be associated with a condition that must be met before the permission attribute is applied.

10. The method as recited in claim 9, wherein the condition comprises a Boolean expression.

11. The method as recited in claim 1, wherein a plurality of permission attributes are applied in a single pass to the sequential entries within the ordered flat file database.

12. A computer system for retrieving data from one or more hierarchically organized data trees maintained in a database comprising:
one or more processors; and
one or more storage devices having stored thereon computer-executable instructions that are executable by the one or more processors, and that configure the system to manage permissions within the database, including computer-executable instructions that configure the computer system to perform at least the following:
identify a query of interest, wherein the query of interest is directed towards returning information gathered from multiple entries within a specific branch of a hierarchically organized data structure;
submit the query of interest to a database system, wherein the database system comprises the hierarchically organized data structure stored within an ordered flat file database; and
receive a query response to the query of interest, wherein the query response is limited to information from at least a portion of the ordered flat file database based upon a permission attribute.

13. The system as recited in claim 12, wherein the permission attribute is applied to sequential entries within the ordered flat file database.

14. The system as recited in claim 13, wherein the query of interest originates from a particular user, which particular user is represented by a particular entry within the hierarchically organized data structure.

15. The system as recited in claim 14, wherein the permission attribute is applied to sequential entries within the ordered flat file database until an terminal entry is reached that indicates there are no further entries within the ordered flat file database that are allowable by the permission attribute.

16. The system as recited in claim 15, wherein:
the permission attribute limits the query to only entries that are within a specific number of levels downstream from the particular entry; and
the terminal entry comprises the first entry sequentially downstream from the particular entry that comprises a relative position within the hierarchically organized data structure that is greater than the particular entry's relative position within the hierarchically organized data structure.

17. The system as recited in claim 14, wherein the permission attribute is associated with at least one specific attribute of the particular user.

18. The system as recited in claim 17, wherein the at least one specific attribute is stored within one or more fields of the particular entry.

19. The system as recited in claim 17, wherein the at least one specific attribute comprises the relative position of particular entry within the hierarchically organized data structure.

20. In a computerized environment, one or more computer storage products having computer-executable instructions stored thereon that, when executed cause one or more processors in a computer system to perform a method for managing permissions within a database, the method comprising the acts of:
receiving a database query directed towards returning information from one or more locations within a hierarchically organized data structure;
identifying a user identification that is associated with the initiation of the database query;
accessing an ordered flat file database, wherein the ordered flat file database comprises the information stored within the hierarchically organized data structure, including information associating each entry within the hierarchically organized data structure with the entry's relative position within the hierarchically organized data structure; and
returning a query response that excludes particular information based on a permission attribute, wherein the permission attribute is applied to sequential entries within the ordered flat file database.
